(19) United States
(12) Patent Application Publication
(10) Pub. No.: US 2014/0247350 A1
(43) Pub. Date: Sep. 4, 2014

(54) TRACKING SYSTEM

(71) Applicant: FOXEYE, INC., Bandar Seri Begawan (BN)

(72) Inventors: SHIH CHUNG CHANG, NEW TAIPEI CITY (TW); HSU-JEN LIN, NEW TAIPEI CITY (TW); CHENG-HAO TSAI, NEW TAIPEI CITY (TW)

(73) Assignee: FOXEYE, INC., Bandar Seri Begawan (BN)

(21) Appl. No.: 14/075,231

(22) Filed: Nov. 8, 2013

(30) Foreign Application Priority Data
Mar. 1, 2013 (TW) 102107235

(51) Int. Cl. H04N 7/18; B60R 11/04

(52) U.S. Cl. CPC H04N 7/18; B60R 11/04
USPC 348/148; 348/143

(57) ABSTRACT

The present invention is related to a tracking system, comprising at least one driver and a master control device having a camera module. The driver and the master control device are each allowed to detect spatial change of body, so as to generate a first/second spatial motion data, respectively. A relative spatial motion data between the master control device and the driver is calculated according to the first/second spatial motion data. The spatial location of the master control device is adjusted or the rotation angle/focal length of the lens of the camera module is adjusted according to the relative spatial motion data, so that the master control device is capable of approaching the driver and the camera module is allowed to focus on the driver. Thus, the master control device of the present invention is allowed to track the driver for monitoring without the need for manual operation.

### FIELD OF THE INVENTION

The present invention is related to a tracking system, particularly to a system capable of tracking objects automatically.

### BACKGROUND

As photographic technique develops rapidly, video cameras have been generally applied to various occasions to shoot. When a user is desired to shoot one specific region or object for monitoring, the shooting angle and focal length of the lens of the camera module may be adjusted manually operation, such that the video camera is focused on the specific region or object. When manual operation is used to adjust the lens of the camera, however, not only some manpower is consumed, but also shooting effect is reduced significantly if the lens of the camera is not adjusted immediately due to inattention of the user to the scene.

Furthermore, the video camera is generally fixed at a specific site to shoot for monitoring when it is further applied for the purpose of monitoring. The monitoring field of vision is limited, however, when the video camera is fixed at the specific site. If the video camera is used for monitoring one moving specific object, the moving specific object is apt to be out of the monitoring field of the video camera, such that subsequent tracking is improbable for the video camera.

### SUMMARY OF THE INVENTION

It is one object of the present invention to provide a tracking system, comprising at least one driver and a master control device, the master control device being provided on a movable vehicle, the master control device being allowed to adjust the spatial location or rotation angle of the vehicle based on relative spatial motion data between the driver and the master control device, such that the master control device is capable of following the driver automatically to achieve a relative motion and approaching the driver for tracking all the time.

It is a further object of the present invention to provide a tracking system, comprising at least one driver and a master control device having a camera module, the master control device being allowed to adjust the rotation angle and focal length of the lens of the camera module based on relative spatial motion data between the driver and the master control device, such that the master control device is capable of tracking the driver for monitoring all the time by means of the camera module.

It is a further object of the present invention to provide a tracking system, comprising at least one driver and a master control device, the driver being provided on a movable vehicle, the master control device being allowed to send an instructing signal to the driver based on relative spatial motion data between the driver and the master control device, the driver being then allowed to adjust the spatial location and/or rotation angle of the vehicle based on instruction of the instructing signal, in such a way that the driver is capable of approaching one specific region/object so as to track the specific region/object.

It is a further object of the present invention to provide a tracking system, comprising at least one driver having a camera module and a master control device, the master control device being allowed to send an instructing signal to the driver based on relative spatial motion data between the driver and the master control device as well as image data shot by the camera module of the driver, the driver being then allowed to adjust the rotation angle and focal length of the lens of the camera module based on instruction of the instructing signal, such that the camera module of the driver is allowed to focus on the specific region/object correctly, so as to shoot the specific region/object for tracking.

To achieve above objects, the present invention provides a tracking system, comprising: at least one driver, comprising: a first motion detector, used for detecting spatial change of the driver so as to generate a first spatial motion data; and a first communication module, connected to the first motion detector, used for transmitting the first spatial motion data; and a master control device, comprising: a second motion detector, used for detecting spatial change of the master control device so as to generate a second spatial motion data; a second communication module, used for receiving the first spatial motion data transmitted from the driver; a camera module; and an operation module, connected to the second motion detector, the second communication module and the camera module, calculating a relative spatial motion data between the driver and the master control device based on the first spatial motion data and the second spatial motion data, adjusting rotation angle and focal length of lens of the camera module based on the relative spatial motion data, such that the camera module is allowed to focus on the driver.

In one embodiment of the present invention, wherein the master control device is provided on a movable vehicle, the vehicle being electrically connected to the operation module, spatial location and/or rotation angle of the vehicle being adjusted by the operation module based on the relative spatial motion data, in such a way that the master control device is allowed to approach the driver.

In one embodiment of the present invention, wherein the driver further comprises a sound receiving module, connected to the first communication module and used for gathering sound generated around the driver so as to generate an audio signal, the audio signal being transmitted to the master control device from the driver through the first communication module, while the audio signal being received by the master control device through the second communication module.

In one embodiment of the present invention, wherein an image data generated by shooting and the audio signal are integrated by the camera module into an audio/video data.

The present invention further provides a tracking system, comprising: at least one driver, comprising: a first motion detector, used for detecting spatial change of the driver so as to generate a first spatial motion data; and a first communication module, connected to the first motion detector, used for transmitting the first spatial motion data; and a master control device, provided on a movable vehicle, comprising: a second motion detector, used for detecting spatial change of the master control device so as to generate a second spatial motion data; a second communication module, used for receiving the first spatial motion data transmitted from the driver; and an operation module, connected to the second motion detector and the second communication module, calculating a relative spatial motion data between the driver and the master control device based on the first spatial motion data and the second spatial motion data, spatial location and/or rotation angle of the vehicle being adjusted on the basis of the relative spatial motion data, in such a way that the master control device is allowed to approach the driver.

The present invention another provides a tracking system, comprising: at least one driver, comprising: a first motion detector, used for detecting spatial change of the driver so as to generate a first spatial motion data; a camera module, shooting one specific region or object, so as to generate an image data; a first communication module, used for transmitting the first spatial motion data and/or the image data; and a control module, connected to the first motion detector, the first communication module and the camera module; and a master control device, comprising: a second motion detector, used for detecting spatial change of the master control device, so as to generate a second spatial motion data; a second communication module, used for receiving the first spatial motion data and/or the image data transmitted from the driver; an operation module, connected to the second motion detector and the second communication module, calculating a relative spatial motion data between the driver and the master control device based on the first spatial motion data and the second spatial motion data, generating an instructing signal based on the relative spatial motion data and/or the image data, the instructing signal being transmitted to the driver via the second communication module, wherein the instructing signal is received by the driver via the first communication module, rotation angle and focal length of lens of the camera module being adjusted by the control module of the driver based on instruction of the instructing signal, such that the camera module is focused on the specific region or object.

In one embodiment of the present invention, wherein the driver is provided on a movable vehicle, the vehicle being electrically connected to the control module, spatial location and/or rotation angle of the vehicle being adjusted by the control module based on instruction of the instructing signal, in such a way that the driver is allowed to approach the specific region or object.

In one embodiment of the present invention, wherein the master control device further comprises a sound receiving module connected to the second communication module, the sound receiving module being used by the master control device to generate an audio signal, and the audio signal being transmitted to the driver via the second communication module, while the audio signal being received by the driver through the first communication module.

The present invention another provides a tracking system, comprising: at least one driver, provided on a movable vehicle, comprising: a first motion detector, used for detecting spatial change of the driver so as to generate a first spatial motion data; and a first communication module, connected to the first motion detector, used for transmitting the first spatial motion data; and a control module, connected to the first motion detector and the first communication module, as well as electrically connected to the vehicle; and a master control device, comprising: a second motion detector, used for detecting spatial change of the master control device so as to generate a second spatial motion data; a second communication module, used for receiving the first spatial motion data transmitted from the driver; and an operation module, connected to the second motion detector and the second communication module, calculating a relative spatial motion data between the driver and the master control device based on the first spatial motion data and the second spatial motion data, generating an instructing signal based on the relative spatial motion data, the instructing signal being transmitted to the driver via the second communication module, wherein the instructing signal is received by the driver via the first communication module, spatial location and/or rotation angle of the vehicle being adjusted by the control module of the driver based on instruction of the instructing signal, in such a way that the driver is allowed to approach one specific region or object.

In one embodiment of the present invention, wherein each of the first motion detector and the second motion detector is a compass, gyroscope, accelerometer, pressure gauge, GPS positioning module and/or a device capable of detecting spatial motion.

In one embodiment of the present invention, wherein each of the first communication module and the second communication module is a WIFI module, Bluetooth module, GSM module and/or a communication module capable of transmitting data.

### BRIEF DESCRIPTION OF DRAWINGS

FIG. 1 is a structural diagram of a tracking system according to one preferred embodiment of the present invention.

FIG. 2 is a circuit diagram of a tracking system according to one preferred embodiment of the present invention.

FIG. 3 is a structural diagram of a tracking system according to a further embodiment of the present invention.

FIG. 4 is a circuit diagram of a tracking system according to a further embodiment of the present invention.

### DETAILED DESCRIPTION

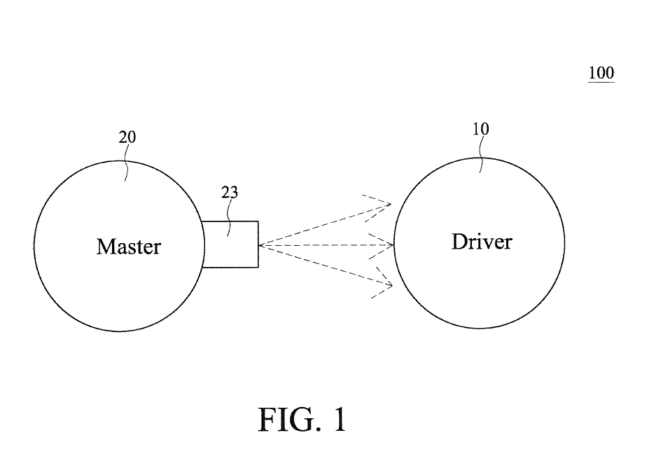

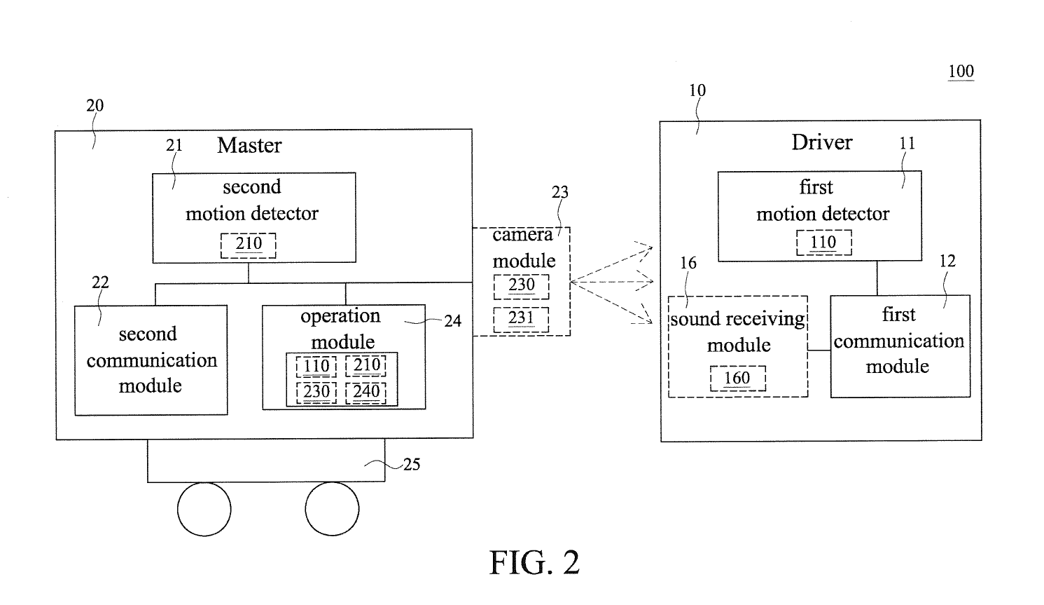

Referring to FIGS. 1 and 2, there are shown a structural diagram and a circuit diagram of a tracking system according to one preferred embodiment of the present invention. The tracking system 100 of the present invention comprises at least one driver 10 and a master control device 20. The driver 10 of this embodiment may be also provided on a moving object to be tracked by the master control device 20, the object being any moving people or articles, such as children, senior citizens, pets, automobiles and so on, for example.

In this case, the driver 10 comprises a first motion detector 11 and a first communication module 12, the first communication module 12 being connected to the first motion detector 11. The master control device 20 comprises a second motion detector 21, a second communication module 22 and an operation module 24, the operation module 24 being connected to the second motion detector 21 and the second communication module 22, respectively. The first motion detector 11 and the second motion detector 21 may be also selected from a compass, gyroscope, accelerometer, pressure gauge, GPS positioning module and/or a device capable of detecting spatial motion, while the first communication module 12 and the second communication module 22 may be also selected from a WIFI module, Bluetooth module, GSM module and/or a communication module capable of transmitting data.

The first motion detector 11 is used for detecting spatial change of the driver 10 so as to generate a first spatial motion data 110, which is transmitted to the master control device 20 via the first communication module 12. The second motion detector 21 is used for detecting spatial change of the master control device 20 so as to generate a second spatial motion data 210. The first spatial motion data 110 transmitted from the driver 10 is received by the master control device 20 via the second communication module 22. A relative spatial motion data 240 between the driver 10 and the master control device 20 is calculated by the operation module 24 based on the first spatial motion data 110 and the second spatial motion data 210.

In one embodiment of the present invention, the master control device 20 may be selectively provided on a movable vehicle 25, such as automobile vehicle, boat vehicle, aerial vehicle and rail vehicle, for example. This vehicle 25 may be electrically connected to the operation module 24 of the master control device 20. The spatial location and/or rotation angle of the vehicle 25 may be adjusted by the operation module 24 of the master control device 20 based on this relative spatial motion data 240, such that the master control device 20 is allowed to follow the driver 10 automatically to achieve a relative motion, and approach the driver 10 for tracking all the time.

Alternatively, in another embodiment of the present invention, the master control device 20 further comprises a camera module 23 connected to the operation module 24. The rotation angle and focal length of the lens of the camera module 23 may be adjusted by the operation module 24 of the master control device 20 based on the relative spatial motion data 240, such that the camera module 23 is allowed to focus on the driver 10 all the time so as to track the driver 10 for monitoring.

As described in above embodiments, the master control device 20 is also selectively allowed to adjust the spatial location/rotation angle of the vehicle 25 so as to track the driver 10 by approaching, or allowed to adjust the rotation angle/focal length of the lens of the camera module 23 so as to track the driver 10 by shooting. It is preferred that, alternatively, not only the rotation angle/focal length of the lens of the camera module 23 may be adjusted, but also the spatial location/rotation angle of the vehicle 25 may be adjusted synchronously by the master control device 20, in such a way that the master control device 20 may be moved to a more suitable location automatically to track the driver 10 for monitoring.

In a further embodiment of the present invention, moreover, the operation module 24 of the master control device 20 is provided with an image recognition algorithm for object, by which one specific driver 10 may be recognized actively from an image data 230 shot by the camera module 21. Then, the rotation angle/focal length of the lens of the camera module 23 and/or the spatial location/rotation angle of the vehicle 25 may be adjusted by the operation module 24 of the master control device 20 based on the relative spatial motion data 240 and/or the recognized image data 230. In this connection, the recognition of image data 230 may be used for facilitating the master control device 20 to lock precisely, and then track one specific driver 10 for monitoring.

Furthermore, the driver 10 of the present invention is further provided with a sound receiving module 16 connected to the first communication module 12. The sound receiving module 16 of the present invention is used for gathering sound generated by the tracked object or sound generated around the driver 10, so as to generate an audio signal 160. The audio signal 160 is transmitted to the master control device 20 from the driver 10 via the first communication module 12, while the audio signal 160 is received by the master control device 20 via the second communication module 22. Afterwards, the shot image data 230 and the audio signal 160 gathered by the sound receiving module 16 may be integrated by the camera module 23 into an audio/video data 231. In this case, the audio/video data 231 with distinct sound may be gathered by the camera module 23 of the master control device 20 from surroundings of the driver 10 if the sound receiving module 16 is disposed on the driver 10.

In this case, the master control device 20 according to the embodiment of the present invention is allowed to track the driver 10 as targeted object for monitoring automatically without manual operation, as well as to adjust the spatial location itself and/or shooting angle/focal length immediately based on the spatial location of the driver 10, so as to expand a zone in which the object may be tracked for monitoring.

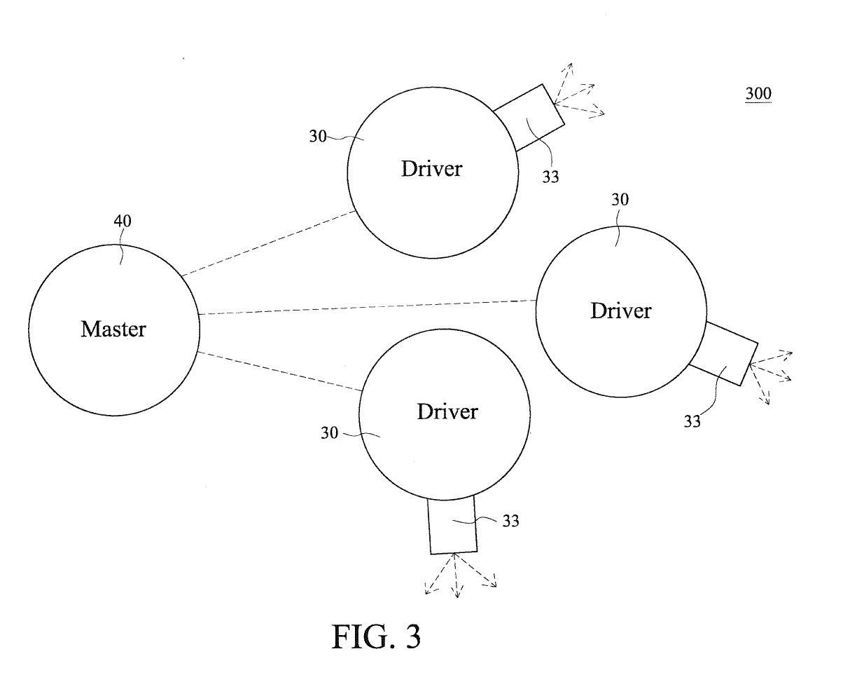

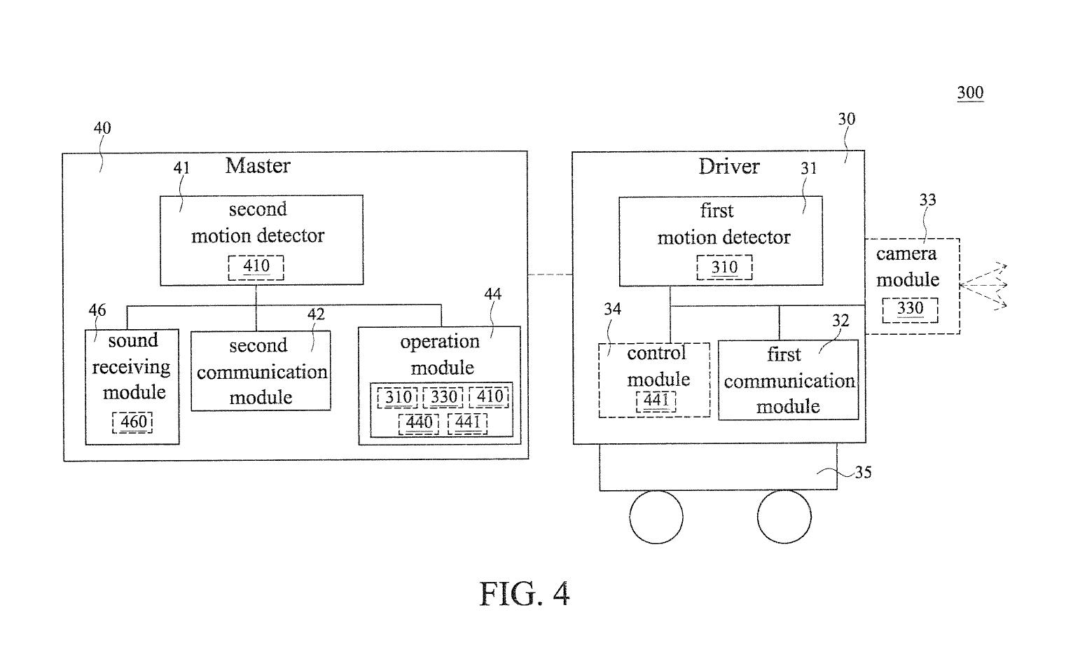

Referring to FIGS. 3 and 4, there are shown a structural diagram and a circuit diagram of a tracking system according to a further embodiment of the present invention. As illustrated in the figures, the tracking system 300 of the present invention comprises at least one driver 30 and a master control device 40. The master control device 40 of the present invention is allowed to instruct the driver 30 to track one specific region and/or object.

In this case, the driver 30 comprises a first motion detector 31, a first communication module 32 and a control module 34, the control module 34 being connected to the first motion detector 31 and the first communication module 32, respectively. The master control device 40 comprises a second motion detector 41, a second communication module 42 and an operation module 44, the operation module 44 being connected to the second motion detector 41 and the second communication module 42, respectively. The first motion detector 31 and the second motion detector 41 may be also selected from a compass, gyroscope, accelerometer, pressure gauge, GPS positioning module and/or a device capable of detecting spatial motion, while the first communication module 32 and the second communication module 42 may be also selected from a WIFI module, Bluetooth module, GSM module and/or a communication module capable of transmitting data.

The first motion detector 31 is used for detecting spatial change of the driver 30 so as to generate a first spatial motion data 310, which is transmitted to the master control device 40 via the first communication module 32. The second motion detector 41 is used for detecting spatial change of the master control device 40 so as to generate a second spatial motion data 410. The first spatial motion data 310 transmitted from the driver 30 is received by the master control device 40 via the second communication module 42. A relative spatial motion data 440 between the driver 30 and the master control device 40 is calculated by the operation module 44 based on the first spatial motion data 310 and the second spatial motion data 410.

In one embodiment of the present invention, the driver 30 may be selectively provided on a movable vehicle 35, which is electrically connected to the control module 34 of the driver 30. An instructing signal 441 is sent by the operation module 44 of the master control device 40 based on the relative spatial motion data 440. This instructing signal 441 is transmitted to the driver 30 via the second communication module 42, while the instructing signal 441 is then received by the driver 30 via the first communication module 32. Afterwards, the spatial location and/or rotation angle of the vehicle 35 may be adjusted by the control module 34 of the driver 30 based on instruction of the instructing signal 441, such that the driver 30 is allowed to approach one specific region and/or object, so as to track the specific region and/or object.

Alternatively, in another embodiment of the present invention, the driver 30 further comprises a camera module 33 connected to the control module 34. The camera module 33 is used to shoot one specific region/object, so as to generate an image data 330. The image data 330 is transmitted to the master control device 40 by the driver 30 via the first communication module 32, and the image data 330 is then received by the master control device 40 via the second communication module 42. In one embodiment of the present invention, furthermore, the operation module 44 of the master control device 40 is provided with an image recognition algorithm for object, by which at least one specific moving object may be recognized actively from image data 330. Then, the instructing signal 441 is sent by the operation module 44 of the master control device 40 based on the relative spatial motion data 440 and/or recognized image data 330. Subsequently, rotation angle and focal length of the lens of the camera module 33 may be adjusted by the control module 34 of the driver 30 based on instruction of the instructing signal 441 after the instructing signal 441 is received, such that the camera module 33 is capable of focusing on the specific region and/or specific moving object, so as to shoot the specific region and/or specific moving object for tracking.

Alternatively, in a further embodiment of the present invention, the rotation angle/focal length of the lens of the camera module 33 and the spatial location/rotation angle of the vehicle 35 may be adjusted simultaneously by the control module 34 of the driver 30 based on instruction of the instructing signal 441, such that the driver 30 may be moved to a location instructed by the master control device 40 to track the specific region and/or object for monitoring.

Furthermore, the master control device 40 of this embodiment further comprises a sound receiving module 46 connected to the second communication module 42. The sound receiving module 46 may be used by the master controller of the master control device 40 to transmit sound signal, further generating an audio signal 460. This audio signal 460 is transmitted to the driver 30 via the second communication module 42, while the audio signal 460 is then received by the driver 30 via the first communication module 32. Afterwards, the slave of the driver 30 may be informed of sound signal transmitted by the master controller desirably by playing audio signal 460 by means of an audio playing element (such as earphone, speaker, for example).

As described above, the master control device 40 of the embodiment of the present invention is allowed to instruct at least one driver 30, based on the requirement of tracking for monitoring, to track the specific region/object for monitoring, as well as to instruct the driver 30, based on the spatial location and/or shot image content of the driver 30, to move spatial location and/or adjust shooting angle/focal length. Thus, it is possible for the driver 30 to track the specific region/object for monitoring correctly.

The above embodiments are used only to illustrate the present invention, and are not intended to limit the scope thereof. Many modifications of the above embodiments can be made without departing from the spirit of the present invention.

1. A tracking system, comprising:
at least one driver, comprising:
a first motion detector, used for detecting spatial change of said driver so as to generate a first spatial motion data; and
a first communication module, connected to said first motion detector, used for transmitting said first spatial motion data; and
a master control device, comprising:
a second motion detector, used for detecting spatial change of said master control device so as to generate a second spatial motion data;
a second communication module, used for receiving said first spatial motion data transmitted from said driver;
a camera module; and
an operation module, connected to said second motion detector, said second communication module and said camera module, calculating a relative spatial motion data between said driver and said master control device based on said first spatial motion data and said second spatial motion data, adjusting rotation angle and focal length of lens of said camera module based on said relative spatial motion data, such that said camera module is allowed to focus on said driver.

2. The tracking system according to claim 1, wherein said master control device is provided on a movable vehicle, said vehicle being electrically connected to said operation module, spatial location and/or rotation angle of said vehicle being adjusted by said operation module based on said relative spatial motion data, in such a way that said master control device is allowed to approach said driver.

3. The tracking system according to claim 1, wherein said driver further comprises a sound receiving module, connected to said first communication module and used for gathering sound generated around said driver so as to generate an audio signal, said audio signal being transmitted to said master control device from said driver through said first communication module, while said audio signal being received by said master control device through said second communication module.

4. The tracking system according to claim 3, wherein an image data generated by shooting and said audio signal are integrated by said camera module into an audio/video data.

5. The tracking system according to claim 1, wherein each of said first motion detector and said second motion detector is a compass, gyroscope, accelerometer, pressure gauge, GPS positioning module and/or a device capable of detecting spatial motion.

6. The tracking system according to claim 1, wherein each of said first communication module and said second communication module is a WIFI module, Bluetooth module, GSM module and/or a communication module capable of transmitting data.

7. A tracking system, comprising:
at least one driver, comprising:
a first motion detector, used for detecting spatial change of said driver so as to generate a first spatial motion data; and
a first communication module, connected to said first motion detector, used for transmitting said first spatial motion data; and
a master control device, provided on a movable vehicle, comprising:
a second motion detector, used for detecting spatial change of said master control device so as to generate a second spatial motion data;
a second communication module, used for receiving said first spatial motion data transmitted from said driver; and
an operation module, connected to said second motion detector and said second communication module, calculating a relative spatial motion data between said driver and said master control device based on said first spatial motion data and said second spatial motion data, spatial location and/or rotation angle of said vehicle being adjusted on the basis of said relative spatial motion data, in such a way that said master control device is allowed to approach said driver.

8. The tracking system according to claim 7, wherein each of said first motion detector and said second motion detector is a compass, gyroscope, accelerometer, pressure gauge, GPS positioning module and/or a device capable of detecting spatial motion.

9. The tracking system according to claim 7, wherein each of said first communication module and said second communication module is a WIFI module, Bluetooth module, GSM module and/or a communication module capable of transmitting data.

10. A tracking system, comprising:
at least one driver, comprising:
a first motion detector, used for detecting spatial change of said driver so as to generate a first spatial motion data;
a camera module, shooting one specific region or object, so as to generate an image data;
a first communication module, used for transmitting said first spatial motion data and/or said image data; and
a control module, connected to said first motion detector, said first communication module and said camera module; and
a master control device, comprising:
a second motion detector, used for detecting spatial change of said master control device, so as to generate a second spatial motion data;
a second communication module, used for receiving said first spatial motion data and/or said image data transmitted from said driver;
an operation module, connected to said second motion detector and said second communication module, calculating a relative spatial motion data between said driver and said master control device based on said first spatial motion data and said second spatial motion data, generating an instructing signal based on said relative spatial motion data and/or said image data, said instructing signal being transmitted to said driver via said second communication module, wherein said instructing signal is received by said driver via said first communication module, rotation angle and focal length of lens of said camera module being adjusted by said control module of said driver based on instruction of said instructing signal, such that said camera module is focused on said specific region or object.

11. The tracking system according to claim 10, wherein said driver is provided on a movable vehicle, said vehicle being electrically connected to said control module, spatial location and/or rotation angle of said vehicle being adjusted by said control module based on instruction of said instructing signal, in such a way that said driver is allowed to approach said specific region or object.

12. The tracking system according to claim 10, wherein said master control device further comprises a sound receiving module connected to said second communication module, said sound receiving module being used by said master control device to generate an audio signal, and said audio signal being transmitted to said driver via said second communication module, while said audio signal being received by said driver through said first communication module.

13. The tracking system according to claim 10, wherein each of said first motion detector and said second motion detector is a compass, gyroscope, accelerometer, pressure gauge, GPS positioning module and/or a device capable of detecting spatial motion.

14. The tracking system according to claim 10, wherein each of said first communication module and said second communication module is a WIFI module, Bluetooth module, GSM module and/or a communication module capable of transmitting data.

15. A tracking system, comprising:
at least one driver, provided on a movable vehicle, comprising:
a first motion detector, used for detecting spatial change of said driver so as to generate a first spatial motion data; and
a first communication module, connected to said first motion detector, used for transmitting said first spatial motion data; and
a control module, connected to said first motion detector and said first communication module, as well as electrically connected to said vehicle; and
a roaster control device, comprising:
a second motion detector, used for detecting spatial change of said master control device so as to generate a second spatial motion data;
a second communication module, used for receiving said first spatial motion data transmitted from said driver; and
an operation module, connected to said second motion detector and said second communication module, calculating a relative spatial motion data between said driver and said master control device based on said first spatial motion data and said second spatial motion data, generating an instructing signal based on said relative spatial motion data, said instructing signal being transmitted to said driver via said second communication module, wherein said instructing signal is received by said driver via said first communication module, spatial location and/or rotation angle of said vehicle being adjusted by said control module of said driver based on instruction of said instructing signal, in such a way that said driver is allowed to approach one specific region or object.

16. The tracking system according to claim 15, wherein said master control device further comprises a sound receiving module connected to said second communication module, said sound receiving module being used by said master control device to generate an audio signal, and said audio signal being transmitted to said driver through said second communication module, while said audio signal being received by said driver through said first communication module.

17. The tracking system according to claim 15, wherein each of said first motion detector and said second motion detector is a compass, gyroscope, accelerometer, pressure gauge, GPS positioning module and/or a device capable of detecting spatial motion.

18. The tracking system according to claim 15, wherein each of said first communication module and said second communication module is a WIFI module, Bluetooth module, GSM module and/or a communication module capable of transmitting data.
